(19) United States
(12) Patent Application Publication
(10) Pub. No.: US 2020/0336708 A1
(43) Pub. Date: Oct. 22, 2020

(54) DUPLICATE MONITORED AREA PREVENTION

(71) Applicant: Xiinova, LLC, Seattl, WA (US)

(72) Inventor: Noam HADAS, Tel-Aviv (IL)

(73) Assignee: Xiinova, LLC, Seattl, WA (US)

(21) Appl. No.: 16/957,360

(22) PCT Filed: Jan. 10, 2018
(86) PCT No.: PCT/US18/13191

§ 371 Date: Jun. 23, 2020

(51) Int. Cl. H04N 7/18; H04W 4/029; G06T 7/73; H04N 5/247; G01S 19/46

(52) U.S. Cl. CPC H04N 7/181; H04W 4/029; G06T 7/74; H04N 5/247; H04N 5/23299; G06T 2207/30201; G06T 2207/30244; G06T 2207/30204; G06T 2207/30232; G01S 19/46

(57) ABSTRACT

Technologies are generally described for prevention of duplicate monitored areas in a surveillance environment. In some examples, a field of view (FOV) of a security personnel may be estimated. An image capture device with a coverage area that potentially includes the FOV of the security personnel may be identified and its FOV estimated as well. Next, an overlap amount between the estimated FOVs of the image capture device and security personnel may be determined. When the overlap amount exceeds a threshold, content provided by the image capture device may be assigned a low priority. The low priority content may be blocked from display, selected with lower priority among multiple available contents, or displayed with an indication of the low priority on a control center display. The FOV of the security personnel may be an actual view of a person or the FOV of a camera associated with the security personnel.

### BACKGROUND

Unless otherwise indicated herein, the materials described in this section are not prior art to the claims in this application and are not admitted to be prior art by inclusion in this section.

A surveillance system for large-scale events or venues may include a number of fixed position or mobile cameras. In addition, a number of security personnel may be on the ground, walking among the crowds and observing the environment. In a typical system, control center personnel may view different video feeds from the cameras and receive audio (or video) feedback from the security personnel on the ground. However, due to the constraint of screen size or the number of videos to be displayed, a limited number of camera videos may be displayed on the screen(s) of a surveillance center. Thus, the control center personnel may miss potentially important events on unselected video feeds or view a scene from a less advantageous perspective (camera's view), whereas a security personnel on the ground may have a better view of the scene.

### SUMMARY

The present disclosure generally describes techniques for prevention of duplicate monitored areas in a surveillance environment.

According to some examples, a method to provide prevention of duplicate monitored areas in a surveillance environment is described. The method may include estimating a field of view (FOV) of a security personnel, identifying an image capture device with a coverage area that potentially includes the FOV of the security personnel, estimating a FOV of the identified image capture device, determining an overlap amount between the estimated FOV of the image capture device and the estimated FOV of the security personnel; and when the overlap amount exceeds a threshold, assigning a low priority to content provided by the image capture device.

According to other examples, a method to provide prevention of duplicate monitored areas in a surveillance environment is described. The method may include receiving content from an image capture device associated with a security personnel, estimating a field of view (FOV) of the image capture device associated with the security personnel, identifying a fixed position image capture device with a coverage area that potentially includes a FOV of the image capture device associated with the security personnel, estimating a FOV of the fixed position image capture device, determining an overlap amount between the estimated FOV of the fixed position image capture device and the estimated FOV of the image capture device associated with the security personnel; and when the overlap amount exceeds a threshold, assigning a low priority to content provided by the fixed position image capture device.

According to other examples, a server configured to provide prevention of duplicate monitored areas in a surveillance environment is described. The server may include a communication interface configured to facilitate communication between the server and a plurality of image capture devices in the surveillance environment, a memory configured to store instructions associated with a surveillance application; and a processor coupled to the communication interface and the memory. The processor may configured to execute the surveillance application and perform actions including estimate a field of view (FOV) of a security personnel, identify an image capture device with a coverage area that potentially includes the FOV of the security personnel, estimate a FOV of the identified image capture device, determine an overlap amount between the estimated FOV of the image capture device and the estimated FOV of the security personnel; and when the overlap amount exceeds a threshold, assign a low priority to content provided by the image capture device.

According to other examples, a surveillance system configured to provide prevention of duplicate monitored areas in a surveillance environment is described. The surveillance system may include a plurality of surveillance image capture devices communicatively coupled to a workstation, a data store communicatively coupled to the workstation and configured to store surveillance related data, the workstation for management of the surveillance system, wherein the workstation comprises a display device configured to display feeds from the plurality of surveillance image capture devices and the surveillance related data from the data store; and a server configured to control the plurality of surveillance image capture devices, the data store, and the workstation. The server may include a communication interface configured to facilitate communication the plurality of surveillance image capture devices, the data store, and the workstation, a memory configured to store instructions; and a processor coupled to the memory and the communication interface. The processor may be configured to estimate a field of view (FOV) of a security personnel, identify an image capture device with a coverage area that potentially includes the FOV of the security personnel, estimate a FOV of the identified image capture device, determine an overlap amount between the estimated FOV of the image capture device and the estimated FOV of the security personnel; and when the overlap amount exceeds a threshold, assign a low priority to content provided by the image capture device.

According to some examples, a method to provide prevention of duplicate monitored areas in a surveillance environment is described. The method may include estimating a field of view (FOV) of a security personnel, identifying an image capture device with a coverage area that potentially includes the FOV of the security personnel, estimating a FOV of the identified image capture device, determining an overlap amount between the estimated FOV of the image capture device and the estimated FOV of the security personnel; and determining whether the overlap amount exceeds a particular threshold.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a conceptual illustration of an example environment, where prevention of duplicate monitored areas in surveillance environments may be implemented;

FIG. 2 includes a conceptual illustration of another example environment, where prevention of duplicate monitored areas in surveillance environments may be implemented;

FIG. 3 illustrates example scenarios where duplication of image capture device monitored areas and security personnel monitored areas may be prevented in surveillance environments;

FIG. 4 illustrates conceptually a system for prevention of duplicate monitored areas in surveillance environments;

FIG. 5 illustrates actions by components of a system for prevention of duplicate monitored areas in surveillance environments;

FIG. 6 illustrates a computing device, which may be used for prevention of duplicate monitored areas in surveillance environments;

FIG. 7 is a flow diagram illustrating an example method for prevention of duplicate monitored areas in surveillance environments that may be performed by a computing device such as the computing device in FIG. 6; and

FIG. 8 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to prevention of duplicate monitored areas in a surveillance environment.

Briefly stated, technologies are generally described for prevention of duplicate monitored areas in a surveillance environment. In some examples, a field of view (FOV) of a security personnel may be estimated. An image capture device with a coverage area that potentially includes the FOV of the security personnel may be identified and its FOV estimated as well. Next, an overlap amount between the estimated FOVs of the image capture device and security personnel may be determined. When the overlap amount exceeds a threshold, content provided by the image capture device may be assigned a low priority. The low priority content may be blocked from display, selected with lower priority among multiple available contents, or displayed with an indication of the low priority on a control center display. The FOV of the security personnel may be an actual view of a person or the FOV of a camera associated with the security personnel.

In the following figures and diagrams, the positioning, structure, and configuration of example systems, devices, and implementation environments have been simplified for clarity. Embodiments are not limited to the configurations illustrated in the following figures and diagrams. Moreover, example embodiments are described using humans as tracking targets in specific example surveillance environments. Embodiments may also be implemented in other types of environment for tracking animals, vehicles, or other mobile objects using the principles described herein.

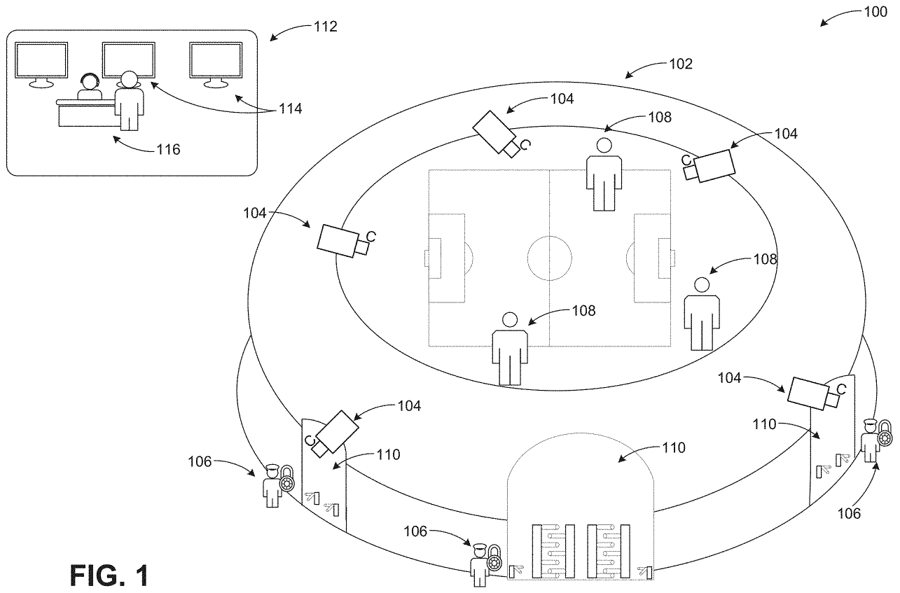

FIG. 1 includes a conceptual illustration of an example environment, where prevention of duplicate monitored areas in surveillance environments may be implemented, arranged in accordance with at least some embodiments described herein.

As shown in diagram 100, a security system for prevention of duplicate monitored areas in surveillance environments may be implemented in a surveillance environment such as a sports venue 102 and include a control center 112, where personnel 116 may observe captured videos and other content of the surveillance environment on display devices 114. The security system may also include a number of image capture devices 104 and “on the ground” security personnel 106. The security personnel 106 may be positioned at strategic locations such as entrance/exit gates 110 to be able to observe people 108 attending an event at the surveillance environment.

The image capture devices 104 may include a stationary camera, a mobile camera, a thermal camera, or a camera integrated in a mobile device, for example. The image capture devices may capture video signals corresponding to respective coverage areas and transmit the video signals to the control center 112 to be processed and displayed on display devices 114. Even if the image capture devices 104 can be manipulated by the control center 112 (e.g., tilt, focus, etc.), the views captured by the cameras may be considered static compared to a view by an on the ground security personnel (through his or her eyes or a body-worn camera). Furthermore, security personnel may have potentially higher flexibility for observation and instantaneous decision-making capability based on being potentially closer to the observed scene (and a target person, for example). Thus, the view—personal or through a body-worn camera—of the security personnel may be considered to have higher value for surveillance purposes. Therefore, the content captured by the image capture device with an FOV that overlaps with the FOV of the security personnel may be considered as having lower priority.

Typical surveillance system configurations, as discussed above, may rely on a large number of cameras and security personnel to observe crowds and events. Prevention of duplicate monitored areas in surveillance environments may allow for more reliable and efficient observation and analysis of crowds and events and thereby enhanced security in surveillance environments.

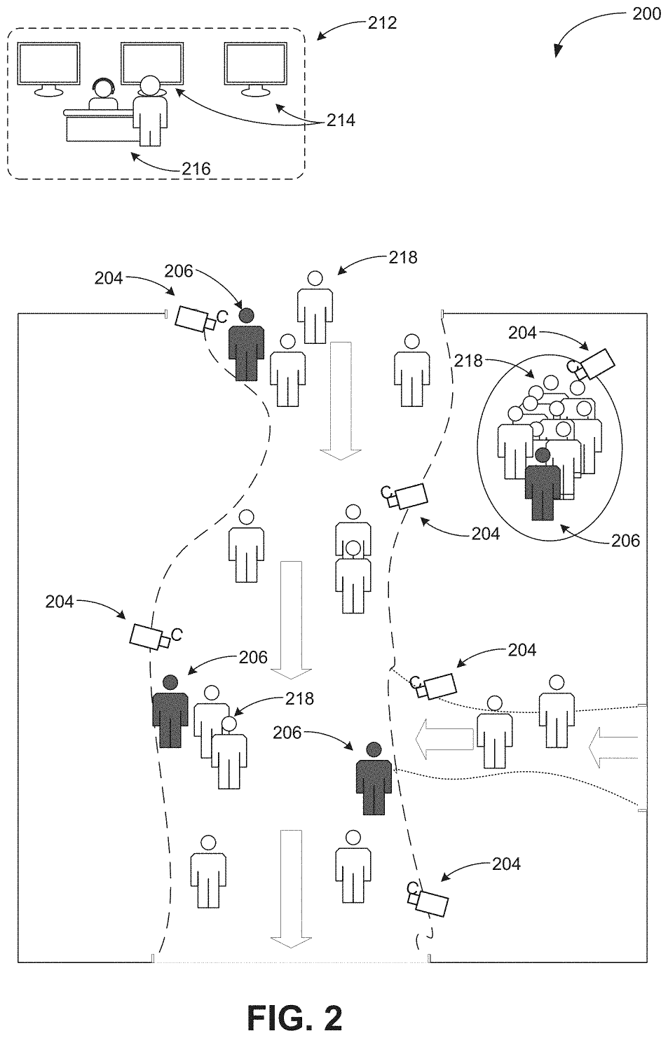

FIG. 2 includes a conceptual illustration of another example environment, where prevention of duplicate monitored areas in surveillance environments may be implemented, arranged in accordance with at least some embodiments described herein.

Diagram 200 shows another example surveillance environment such as a park, street, or similar location. An example security system for prevention of duplicate monitored areas in surveillance environments implemented in the example surveillance environment may include a control center 212, where personnel 216 may observe captured videos and other content of the surveillance environment on display devices 214. The security system may also include a number of image capture devices 204 and “on the ground” security personnel 206. The security personnel 206 may be positioned at strategic locations such as main walkways, connection points, and other gathering areas, where crowds 218 may gather and/or move.

As discussed above, FOVs of security personnel may be compared to FOVs of image capture devices with coverage areas that potentially overlap with a view of a security personnel, and overlaps in the FOVs may be determined. Content captured (and transmitted to the control center 212) by the image capture devices whose FOV overlaps with that of a security personnel may be assigned a lower priority. The lower priority may be used to block the captured content from being displayed at the control center 212, selected for display based on the lower priority, or displayed with an indication of the lower priority to alert a control center personnel 216.

In some examples, a surveillance application that controls video presentation at the control center 212 may receive information associated with a location and a gaze direction of each security personnel. The surveillance application may determine an area within a visual field of each security personnel over time. For example, the surveillance application may model a pie section with the security personnel at its tip and a spread of about 30 degrees to the left and right of the gaze direction. A radius of the modeled pie section may be inversely proportional to a density of the people in a vicinity of the security personnel. The system may search a map of image capture device coverage when the area monitored by a security personnel is defined. If any of the image capture devices' FOV is sufficiently overlapping with the visual field of any of the security personnel, content from the identified image capture device may be assigned a lower priority for display.

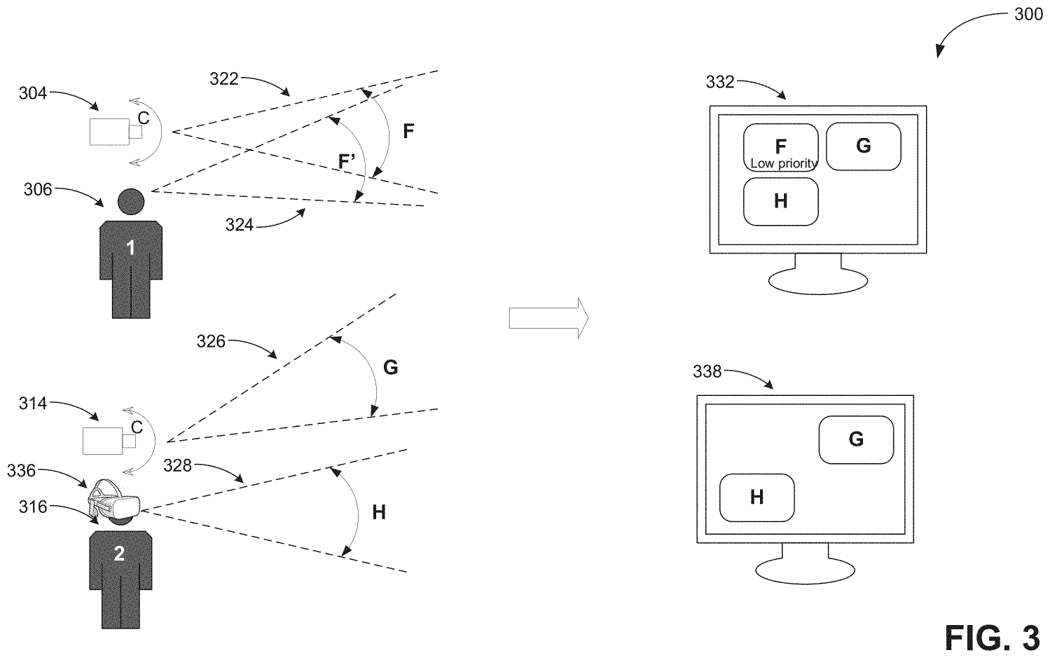

FIG. 3 illustrates example scenarios where duplication of image capture device monitored areas and security personnel monitored areas may be prevented in surveillance environments, arranged in accordance with at least some embodiments described herein.

Diagram 300 shows example scenarios according to some embodiments. A first scenario may include a surveillance camera 304 with a FOV 322 (F) and a first security personnel 306, whose FOV (personal view) 324 (F′) may overlap substantially with the FOV 322 (F) of the surveillance camera 304. In a second scenario, another surveillance camera 314 may have a FOV 326 (G), which may not overlap with the FOV 328 (H) of a second security personnel 316. The FOV 328 (H) of the second security personnel 316 may be the FOV of a wearable camera 336 (e.g., augmented reality “AR” glasses).

Presentation options for captured content based on the two example scenarios may include display 332 of content from the surveillance camera 304, from the other surveillance camera 314, and from the wearable camera 336 (F, G, and H) with an indication of the content from the surveillance camera 304 (F) as low priority because the FOV 324 (F′) of the first security personnel 306 substantially overlaps with that content. Another presentation option may include display 338 of the content from surveillance camera 314 (G) and from the wearable camera 336 (H) only because the FOVs of the surveillance camera 304 and the first security personnel 306 substantially overlap. Thus, the control center can rely on the first security personnel 306 to observe the area in the overlapping FOVs.

The FOV of the security personnel may be estimated based on receiving location information for the security personnel, detecting a gaze direction and/or a head tilt of the security personnel, and modelling the FOV as a two-dimensional pie section based on the location, gaze direction, and head tilt of the security personnel. The two-dimensional pie section may have an origin, a radius, and a span with the security personnel located at the origin of the pie section, the radius corresponding to an estimated depth of field, and the span corresponding to estimated visible range of the security personnel. In some examples, the FOV may be modelled through adjustment of the radius as inversely proportional to a density of people identified in a vicinity of the security personnel. An azimuth and an elevation of the FOV of the security personnel may also be determined from the detected gaze direction and the detected head tilt and considered in the model. In other examples, the FOV may be modelled as a three-dimensional pie section with parameters similar to the two-dimensional model, where the three-dimensional pie section may be horizontally centered around the gaze direction and vertically centered around the head tilt.

Location of the security personnel may be determined based receiving global positioning system (GPS) information from a wearable device or a mobile device on the security personnel, in some examples. In other examples, the location may be estimated based on an analysis of the detected gaze direction and/or head tilt of the security personnel. In further examples, the security personnel may be detected on feeds from two or more image capture devices, and the location of the security personnel may be computed based on an analysis of the feeds from the two or more image capture devices. Moreover, the location of the security personnel may be estimated through near-field communication with a wearable device or a mobile device on the security personnel. In other examples, wireless local area network triangulation or cellular communication triangulation of a wearable device or a mobile device on the security personnel may also be used for location determination. Radar, lidar, ultrasound, or similar ranging may also be used for location estimation. The gaze direction and/or the head tilt of the security personnel may be estimated based on information received from a compass based sensor or a gyroscopic sensor on the security personnel. The gaze direction and/or the head tilt of the security personnel may also be estimated based on an analysis of captured images of the security personnel's face from feed from at least two image capture devices.

Embodiments may also be implemented in other configurations. For example, upon determining the FOV of a first image capture device the FOV of another image capture device may be determined and used instead of or to complement the FOV of the first image capture device. In some implementations, the first and second image capture devices may be fixed and movable cameras, respectively. For example, a fixed camera and a steerable camera or a fixed camera and a drone camera may be used based on their respective FOVs. In yet other examples, two or more image capture devices may be used to supplement or replace the FOV of a single image capture device or a security personnel. For example, a server may determine that a combination of FOVs of two cameras (of any type) may overlap with the FOV of another camera of a security personnel. The other camera may be a steerable one, for example. In such a scenario, the server may use the combination FOV for the particular coverage area and instruct the other camera or the security personnel to focus on a different coverage area.

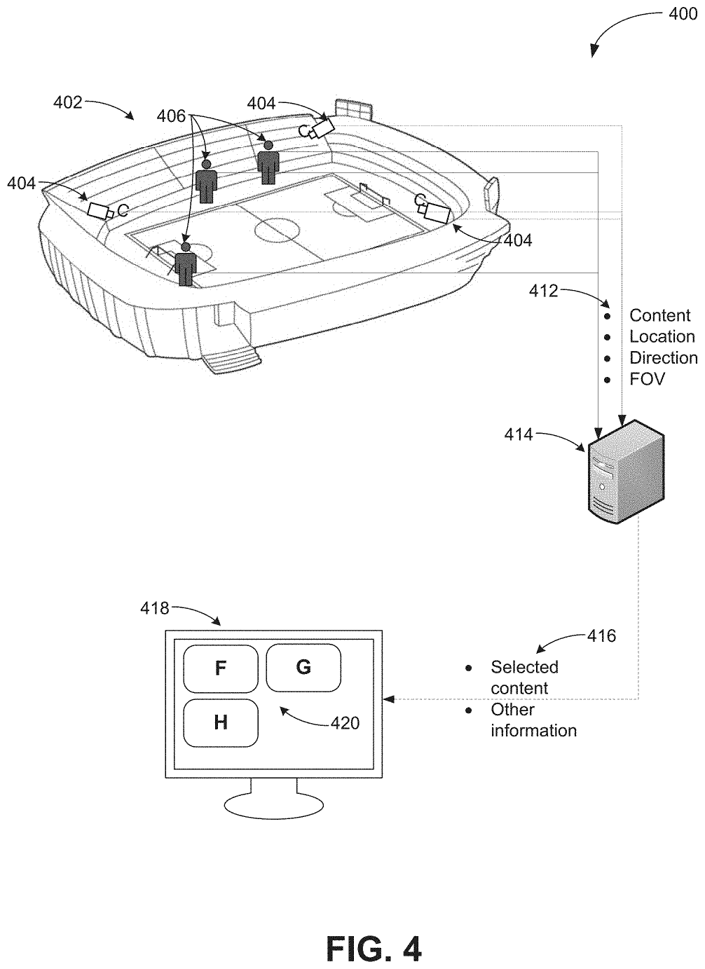

FIG. 4 illustrates conceptually a system for prevention of duplicate monitored areas in surveillance environments, arranged in accordance with at least some embodiments described herein.

Diagram 400 shows an example configuration, where a stadium 402 (surveillance environment) may be surveilled by cameras 404 and security personnel 406. A server 414, which may execute a surveillance or security application, may receive information 412 from the cameras 404 and security personnel 406. The received information 412 may include, but is not limited to, captured content (from the cameras 404 and/or any image capture devices on the security personnel 406), location information (e.g., of the security personnel 406), direction information (e.g., gaze direction and head tilt for the security personnel 406 or direction of the cameras 404), and FOV related information (e.g., range or focus of the cameras 404). The server 414 may process the received information and select content 420 to be presented on a display device 418 at a control center (or individual security personnel display devices), as well as, other information (416).

The server 414 may estimate the FOVs of the security personnel, and identify image capture devices with coverage areas that potentially include the FOVs of the respective security personnel. The server 414 may estimate the FOVs of the identified image capture devices and estimate overlap amounts between the estimated FOVs of the image capture devices and the respective security personnel. When an overlap amount for a pair of security personnel and image capture device exceeds a threshold, the server 414 may assign that content provided by the image capture device a low priority. The low priority content may be blocked from display, selected with lower priority among multiple available contents, or displayed with an indication of the low priority on a control center display.

The server 414 may assign the low priority as a numerical value from a range of distinct values (e.g., 1 through 10), for example. In other examples, the priority may be binary (e.g., low or high). In determining the priority to be assigned, other factors such as characteristics of the image capture device (e.g., whether the image capture device can be manipulated to improve the captured content) or characteristics of the security personnel (e.g., an experience level or a hierarchical level such as supervisor) may also be taken into consideration.

In an example scenario, if the security personnel happens to be on a higher place compared to the observed crowd, a distance covered by the security personnel may be larger and thus preferred over an overlapping camera. Conversely, if the security personnel is in a lower position compared to the observed crowd, his or her FOV may not be preferred over an overlapping camera's FOV. If a security personnel is shifting their gaze direction continuously, an entire sweep angle may be used to estimate the visible area covered by this security personnel. Moreover, any obstacles in the security personnel's line of sight such a pillars or screens may be taken into consideration as well.

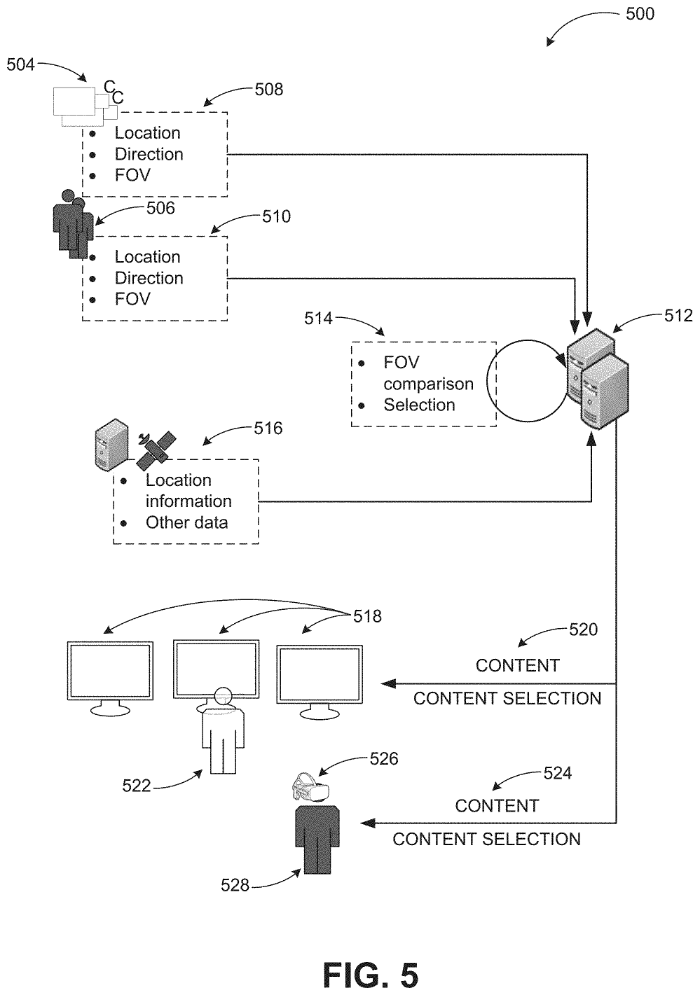

FIG. 5 illustrates actions by components of a system for prevention of duplicate monitored areas in surveillance environments, arranged in accordance with at least some embodiments described herein.

Diagram 500 includes surveillance cameras 504 with characteristics 508 such as location, direction, and FOV, and security personnel 506 with characteristics 510 such as location, direction, and FOV. Information associated with the characteristics of the surveillance cameras 504 and security personnel 506 may be provided to a server 512, which may perform tasks 514 such as surveillance camera and security personnel FOV estimation, estimation of an overlap amount between respective FOVs, and selection of content captured by the surveillance cameras 504 for display on one or more of the display devices 518. In performing the tasks, the server 512 may receive information 516 such as location information and other data from a variety of sources such as a GPS system, wireless networks, sensors on the security personnel, etc.

The server 512 may provide content (and content selection) 520 to the display devices 518 to be viewed by control center personnel 522. In some examples, the server 512 may select content to be displayed based on the FOV overlaps and provide to the display devices 518. In other examples, the server 512 may augment some content with assigned priority information and provide to the display devices 518. In further examples, the server 512 may provide all available content and content selection information to a control center console such that automatic or manual selection can be made at the console. In yet other examples, the server 512 may provide content (and content selection) 524 to display devices associated with on the ground security personnel 528 such as augmented reality (AR) glasses 526.

According to some embodiments, the FOV of an image capture device (e.g., surveillance camera) identified as having a potential overlap with a security personnel may be estimated based on received characteristic information associated with the identified image capture device. The characteristic information may include an azimuth, an elevation, an angle of view, and/or a focal point. Content assigned a low priority may be displayed at a security control center with an indication of the low priority or temporarily blocked from being displayed until the overlap amount drops below the threshold and the content is no longer assigned the low priority. The estimated FOV of the security personnel may be updated periodically or in response to a detection of one of a location change, a gaze direction change, or a head tilt change by the security personnel. The estimated FOV of the image capture device (in cases, where the image capture devices are not fixed) may be updated periodically or on-demand, as well. The overlap amount between the FOV of the image capture device and the FOV of the security personnel may also be updated based on the updated FOVs.

In further examples, instructions may be sent to the security personnel if the FOV overlap amount exceeds the particular threshold. The security personnel may be instructed to modify one or more of a gaze direction, a head tilt, or a location of the security personnel in order to change their FOV. Similarly, the FOV of an image capture device with an overlapping FOV with a security personnel may be modified by changing an azimuth, elevation, location, or focal point of the image capture device.

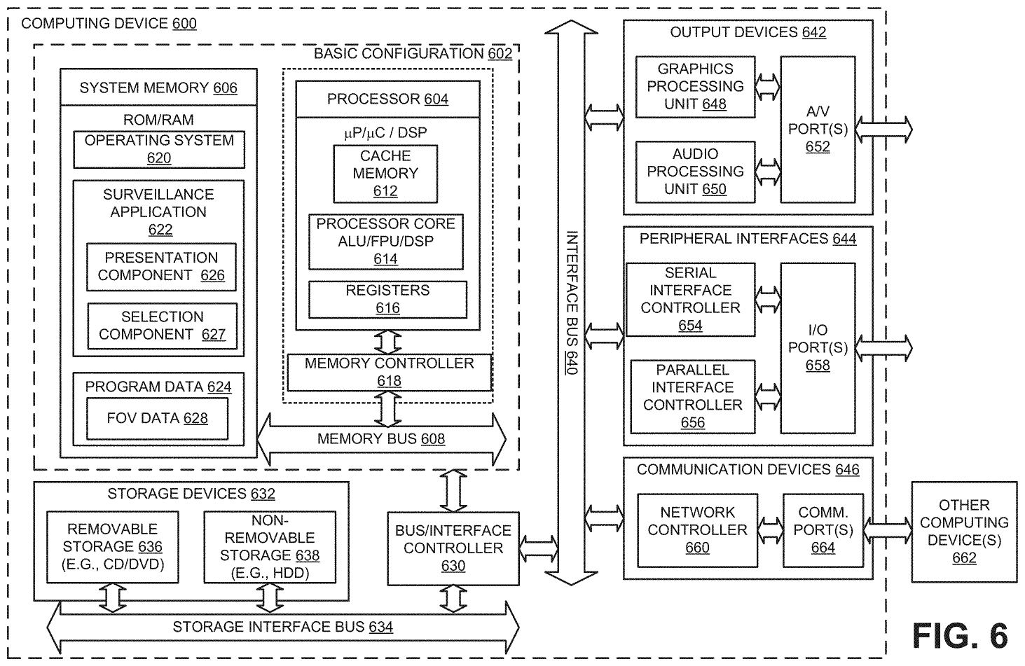

FIG. 6 illustrates a computing device, which may be used for prevention of duplicate monitored areas in surveillance environments, arranged with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a surveillance application 622, and program data 624. The surveillance application 622 may include a presentation component 626 and a selection component 627. The surveillance application 622 may be configured to provide prevention of duplicate monitored areas in a surveillance environment by estimating a field of view (FOV) of a security personnel and identifying an image capture device with a coverage area that potentially includes the FOV of the security personnel. The FOV of the identified image capture device may be estimated as well, and an overlap amount between the estimated FOVs of the image capture device and security personnel may be determined. When the overlap amount exceeds a threshold, content provided by the image capture device may be assigned a low priority. In conjunction with the presentation component 626 and the selection component 627, the surveillance application 622 may block the low priority content from display, select with lower priority among multiple available contents, or display with an indication of the low priority on a control center display. The program data 624 may include, among other data, FOV data 628 or the like, as described herein.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 644, and one or more communication devices 646) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664. The one or more other computing devices 662 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer that includes any of the above functions. The computing device 600 may also be implemented as a personal computer including both laptop computer and non-laptop computer configurations.

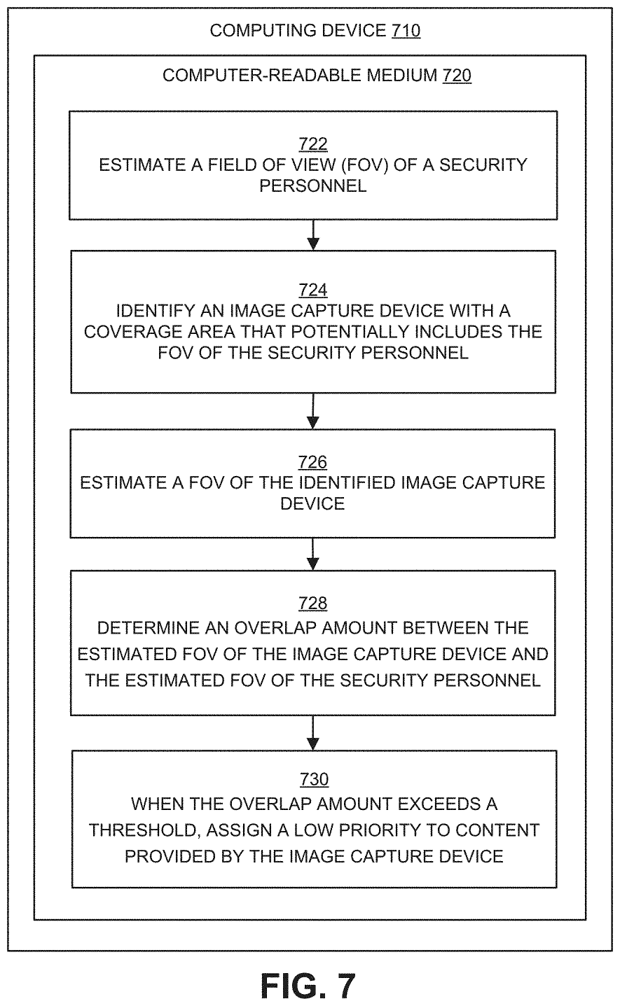

FIG. 7 is a flow diagram illustrating an example method for prevention of duplicate monitored areas in surveillance environments that may be performed by a computing device such as the computing device in FIG. 6, arranged with at least some embodiments described herein.

Example methods may include one or more operations, functions, or actions as illustrated by one or more of blocks 722, 724, 726, 728, and/or 730, and may in some embodiments be performed by a computing device such as the computing device 710 in FIG. 7. Such operations, functions, or actions in FIG. 7 and in the other figures, in some embodiments, may be combined, eliminated, modified, and/or supplemented with other operations, functions or actions, and need not necessarily be performed in the exact sequence as shown. The operations described in the blocks 722-730 may also be implemented through execution of computer-executable instructions stored in a computer-readable medium such as a computer-readable medium 720 of a computing device 710.

An example process for prevention of duplicate monitored areas in surveillance environments may begin with block 722, “ESTIMATE A FIELD OF VIEW (FOV) OF A SECURITY PERSONNEL”, where a FOV of a security personnel within a surveillance environment may be estimated. The FOV of the security personnel may be an actual view of a person or the FOV of a camera associated with the security personnel. The FOV of the security personnel may be estimated based on a gaze, a location, and/or a head tilt of the security personnel in some examples.

Block 722 may be followed by block 724, “IDENTIFY AN IMAGE CAPTURE DEVICE WITH A COVERAGE AREA THAT POTENTIALLY INCLUDES THE FOV OF THE SECURITY PERSONNEL”, where a fixed or mobile image capture device associated with a security system monitoring the surveillance environment may be identified based on a coverage area of the image capture device potentially overlapping with the FOV of the security personnel. The image capture device may include a stationary camera, a mobile camera, a thermal camera, a camera integrated in a mobile device, or a body-mounted camera, for example.

Block 724 may be followed by block 726, “ESTIMATE A FOV OF THE IDENTIFIED IMAGE CAPTURE DEVICE”, where the FOV of the identified image capture device may be estimated based on characteristics of the image capture device such as an azimuth, an elevation, an angle of view, and/or a focal point of the image capture device, for example.

Block 726 may be followed by block 728, “DETERMINE AN OVERLAP AMOUNT BETWEEN THE ESTIMATED FOV OF THE IMAGE CAPTURE DEVICE AND THE ESTIMATED FOV OF THE SECURITY PERSONNEL”, where an overlap between the estimated FOVs of the security personnel and the identified image capture device may be determined. The FOVs and the overlap may be determined in two dimensions or three dimensions. The overlap amount may be quantified to compare against a threshold.

Block 728 may be followed by block 730, “WHEN THE OVERLAP AMOUNT EXCEEDS A THRESHOLD, ASSIGN A LOW PRIORITY TO CONTENT PROVIDED BY THE IMAGE CAPTURE DEVICE”, where the overlap amount may be compared to a threshold. If the overlap exceeds the threshold, the content captured by the image capture device may be assigned a low priority. Due to potentially higher flexibility for observation and instantaneous decision-making capability of a security personnel, who is potentially closer to the observed scene (and a target person, for example), the view—personal or through a body-worn camera—of the security personnel may be considered to have higher value for surveillance purposes. Thus, the content captured by the image capture device with overlapping FOV may be considered as having lower priority. The lower priority assignment may be used in selection of the content for display in a control center and/or display of the content with an indication of its priority level.

The operations included in the example process are for illustration purposes. Prevention of duplicate monitored areas in surveillance environments may be implemented by similar processes with fewer or additional operations, as well as in different order of operations using the principles described herein. The operations described herein may be executed by one or more processors operated on one or more computing devices, one or more processor cores, specialized processing devices, and/or general purpose processors, among other examples.

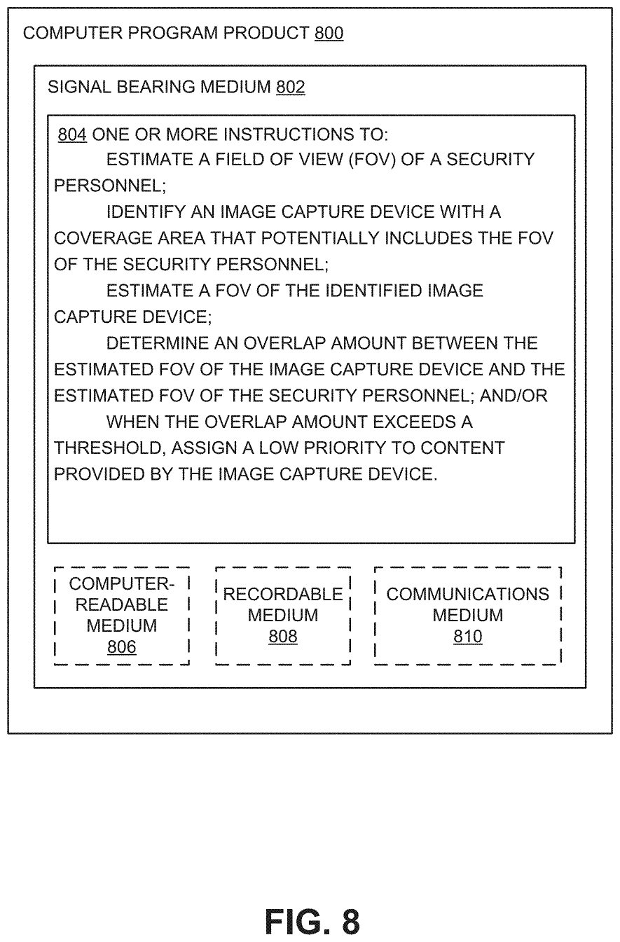

FIG. 8 illustrates a block diagram of an example computer program product, arranged in accordance with at least some embodiments described herein.

In some examples, as shown in FIG. 8, a computer program product 800 may include a signal bearing medium 802 that may also include one or more machine readable instructions 804 that, in response to execution by, for example, a processor may provide the functionality described herein. Thus, for example, referring to the processor 604 in FIG. 6, the surveillance application 622 may perform or control performance of one or more of the tasks shown in FIG. 8 in response to the instructions 804 conveyed to the processor 604 by the signal bearing medium 802 to perform actions associated with the prevention of duplicate monitored areas in a surveillance environment as described herein. Some of those instructions may include, for example, estimate a field of view (FOV) of a security personnel; identify an image capture device with a coverage area that potentially includes the FOV of the security personnel; estimate a FOV of the identified image capture device; determine an overlap amount between the estimated FOV of the image capture device and the estimated FOV of the security personnel; and/or when the overlap amount exceeds a threshold, assign a low priority to content provided by the image capture device, according to some embodiments described herein.

In some implementations, the signal bearing medium 802 depicted in FIG. 8 may encompass computer-readable medium 806, such as, but not limited to, a hard disk drive (HDD), a solid state drive (SSD), a compact disc (CD), a digital versatile disk (DVD), a digital tape, memory, etc. In some implementations, the signal bearing medium 802 may encompass recordable medium 808, such as, but not limited to, memory, read/write (R/W) CDs, R/W DVDs, etc. In some implementations, the signal bearing medium 802 may encompass communications medium 810, such as, but not limited to, a digital and/or an analog communication medium (e.g., a fiber optic cable, a waveguide, a wired communication link, a wireless communication link, etc.). Thus, for example, the computer program product 800 may be conveyed to one or more modules of the processor 604 by an RF signal bearing medium, where the signal bearing medium 802 is conveyed by the communications medium 810 (e.g., a wireless communications medium conforming with the IEEE 802.11 standard).

According to some examples, a method to provide prevention of duplicate monitored areas in a surveillance environment is described. The method may include estimating a field of view (FOV) of a security personnel, identifying an image capture device with a coverage area that potentially includes the FOV of the security personnel, estimating a FOV of the identified image capture device, determining an overlap amount between the estimated FOV of the image capture device and the estimated FOV of the security personnel; and when the overlap amount exceeds a threshold, assigning a low priority to content provided by the image capture device.

According to other examples, estimating the FOV of the security personnel may include receiving location information for the security personnel, detecting one or more of a gaze direction and a head tilt of the security personnel; and modelling the FOV as a two-dimensional pie section based on the detected one or more of the gaze direction and the head tilt of the security personnel, the two-dimensional pie section having an origin, a radius, and a span, wherein the modelled FOV has the security personnel being located at the origin of the pie section, the radius corresponds to an estimated depth of field, and the span corresponds to estimated visible range of the security personnel. Modelling the FOV may include adjusting the radius as inversely proportional to a density of people identified in a vicinity of the security personnel. Estimating the FOV of the security personnel may further include receiving location information for the security personnel, detecting one or more of a gaze direction and a head tilt of the security personnel; and determining an azimuth and an elevation of the FOV of the security personnel from the detected gaze direction and the detected head tilt. Estimating the FOV of the security personnel may also include receiving location information for the security personnel, detecting one or more of a gaze direction and a head tilt of the security personnel; and modelling the FOV as a three-dimensional pie section based on the detected one or more of the gaze direction and the head tilt of the security personnel, the three-dimensional pie section having an origin, a radius, and a span, wherein the modelled FOV has the security personnel being located at the origin of the pie section, the radius corresponds to an estimated depth of field, the span corresponds to estimated visible range of the security personnel, and the three-dimensional pie section is horizontally centered around the gaze direction and vertically centered around the head tilt.

According to further examples, modelling the FOV may further include adjusting the radius as inversely proportional to a density of people identified in a vicinity of the security personnel. Estimating the FOV of the security personnel may further include receiving global positioning system (GPS) information from a wearable device or a mobile device on the security personnel, detecting a gaze direction of the security personnel, detecting the security personnel on feeds from two or more image capture devices; and computing a location of the security personnel based on an analysis of the feeds from the two or more image capture devices. Estimating the FOV of the security personnel may also include detecting one or more of a gaze direction and a head tilt of the security personnel from the feeds from the two or more image capture devices, computing the FOV of the security personnel based on an analysis of the detected one or more of the gaze direction and the head tilt, estimating a location of the security personnel through near-field communication with a wearable device or a mobile device on the security personnel, detecting a gaze direction of the security personnel, estimating a location of the security personnel through wireless local area network triangulation or cellular communication triangulation of a wearable device or a mobile device on the security personnel, detecting a gaze direction of the security personnel, estimating a location of the security personnel through ranging from known locations of two or more image capture devices; and detecting a gaze direction of the security personnel. Estimating the FOV of the security personnel may further include estimating a location of the security personnel through one or more of radar, lidar, or ultrasound ranging, detecting a gaze direction of the security personnel, receiving location information for the security personnel, detecting one or more of a gaze direction and a head tilt of the security personnel based on information received from a compass based sensor or a gyroscopic sensor on the security personnel, estimating the FOV based on the location and the one or more of the gaze direction and the head tilt, capturing images of the security personnel's face from feed from at least two image capture devices, estimating a gaze direction and head tilt of the security personnel based on an analysis of the captured images.

According to yet other examples, estimating the FOV of the identified image capture device may include receiving characteristic information associated with the identified image capture device, the characteristic information comprising one or more of an azimuth, an elevation, an angle of view, and a focal; and computing the FOV of the identified image capture device based on the characteristic information. The method may further include displaying the content provided by the image capture device at a security control center with an indication of the low priority, temporarily blocking the content provided by the image capture device from being displayed at a security control center until the overlap amount drops below the threshold and the content is no longer assigned the low priority, updating the estimated FOV of the security personnel periodically or in response to a detection of one of a location change, a gaze direction change, or a head tilt change by the security personnel; and updating the determined overlap amount between the FOV of the image capture device and the FOV of the security personnel based on the updated estimated FOV.

According to other examples, a method to provide prevention of duplicate monitored areas in a surveillance environment is described. The method may include receiving content from an image capture device associated with a security personnel, estimating a field of view (FOV) of the image capture device associated with the security personnel, identifying a fixed position image capture device with a coverage area that potentially includes a FOV of the image capture device associated with the security personnel, estimating a FOV of the fixed position image capture device, determining an overlap amount between the estimated FOV of the fixed position image capture device and the estimated FOV of the image capture device associated with the security personnel; and when the overlap amount exceeds a threshold, assigning a low priority to content provided by the fixed position image capture device.

According to further examples, determining the overlap amount between the estimated FOV of the fixed position image capture device and the estimated FOV of the image capture device associated with the security personnel may include comparing one or more markers detected in the content from the image capture device associated with the security personnel and in content from the fixed position image capture device. Comparing one or more markers detected in the content from the image capture device associated with the security personnel and in the content from the fixed position image capture device may include comparing one or more of a feature on a detected person, an architectural feature of the surveillance environment, or a lighting fixture. Receiving the content from the image capture device associated with the security personnel may include receiving the content from one of a body-worn image capture device, a mobile image capture device, a smart phone image capture device, or an augmented reality (AR) glasses image capture device. Estimating the FOV of the image capture device associated with the security personnel further may include receiving global positioning system (GPS) information from a wearable device or a mobile device on the security personnel.

Estimating the FOV of the image capture device associated with the security personnel may further include detecting the security personnel on feeds from two or more fixed position image capture devices; and computing a location of the security personnel based on an analysis of the feeds from the two or more fixed position image capture devices. Estimating the FOV of the image capture device associated with the security personnel may also include estimating a location of the security personnel through near-field communication with a wearable device or a mobile device on the security personnel. Estimating the FOV of the image capture device associated with the security personnel may further include estimating a location of the security personnel through wireless local area network triangulation or cellular communication triangulation of a wearable device or a mobile device on the security personnel.

According to some examples, estimating the FOV of the image capture device associated with the security personnel may further include estimating a location of the security personnel through ranging from known locations of two or more fixed position image capture devices. Estimating the FOV of the image capture device associated with the security personnel may further include estimating a location of the security personnel through one or more of radar, lidar, or ultrasound ranging, receiving location information for the security personnel, detecting one or more of an azimuth and an elevation of the image capture device associated with the security personnel based on information received from a compass based sensor or a gyroscopic sensor associated with the image capture device; and estimating the FOV based on the location and the one or more of the azimuth and the elevation. The method may also include displaying the content provided by the fixed position image capture device at a security control center with an indication of the low priority, temporarily blocking the content provided by the fixed position image capture device from being displayed at a security control center until the overlap amount drops below the threshold and the content is no longer assigned the low priority, updating the estimated FOV of the image capture device associated with the security personnel periodically or in response to a detection of a location change by the security personnel; and updating the determined overlap amount between the FOV of the fixed position image capture device and the FOV of the image capture device associated with the security personnel based on the updated estimated FOV.

According to other examples, a server configured to provide prevention of duplicate monitored areas in a surveillance environment is described. The server may include a communication interface configured to facilitate communication between the server and a plurality of image capture devices in the surveillance environment, a memory configured to store instructions associated with a surveillance application; and a processor coupled to the communication interface and the memory. The processor may be configured to execute the surveillance application and perform actions including estimate a field of view (FOV) of a security personnel, identify an image capture device with a coverage area that potentially includes the FOV of the security personnel, estimate a FOV of the identified image capture device, determine an overlap amount between the estimated FOV of the image capture device and the estimated FOV of the security personnel; and when the overlap amount exceeds a threshold, assign a low priority to content provided by the image capture device.

According to yet other examples, the processor may be further configured to estimate the FOV of the security personnel through: receipt of location information for the security personnel, detection of one or more of a gaze direction and a head tilt of the security personnel, and generation of a model for the FOV as a two-dimensional pie section based on the detected one or more of the gaze direction and the head tilt of the security personnel, the two-dimensional pie section having an origin, a radius, and a span, wherein the model has the security personnel being located at the origin of the pie section, the radius corresponds to an estimated depth of field, and the span corresponds to estimated visible range of the security personnel. The processor may also be configured to generate the model for the FOV through adjustment of the radius as inversely proportional to a density of people identified in a vicinity of the security personnel. The processor may further be configured to estimate the FOV of the security personnel through: receipt of location information for the security personnel; detection of one or more of a gaze direction and a head tilt of the security personnel; and determination of an azimuth and an elevation of the FOV of the security personnel from the detected gaze direction and the detected head tilt. The processor may further be configured to estimate the FOV of the security personnel through: receipt of location information for the security personnel; detection of one or more of a gaze direction and a head tilt of the security personnel; and generation of a model for the FOV as a three-dimensional pie section based on the detected one or more of the gaze direction and the head tilt of the security personnel, the three-dimensional pie section having an origin, a radius, and a span, wherein the model for the FOV has the security personnel being located at the origin of the pie section, the radius corresponds to an estimated depth of field, the span corresponds to estimated visible range of the security personnel, and the three-dimensional pie section is horizontally centered around the gaze direction and vertically centered around the head tilt. The processor may also be configured to generate the model for the FOV further comprises adjusting the radius as inversely proportional to a density of people identified in a vicinity of the security personnel. The processor may further be configured to estimate the FOV of the security personnel through: receipt of global positioning system (GPS) information from a wearable device or a mobile device on the security personnel; detection of a gaze direction of the security personnel, detection of the security personnel on feeds from two or more image capture devices; and computation of a location of the security personnel based on an analysis of the feeds from the two or more image capture devices.

According to further examples, the processor may also be configured to estimate the FOV of the security personnel through: detection of one or more of a gaze direction and a head tilt of the security personnel from the feeds from the two or more image capture devices, computation of the FOV of the security personnel based on an analysis of the detected one or more of the gaze direction and the head tilt, estimation of a location of the security personnel through near-field communication with a wearable device or a mobile device on the security personnel, detection of a gaze direction of the security personnel, estimation of a location of the security personnel through wireless local area network triangulation or cellular communication triangulation of a wearable device or a mobile device on the security personnel, detection of a gaze direction of the security personnel, estimation of a location of the security personnel through ranging from known locations of two or more image capture devices; and detection of a gaze direction of the security personnel. The processor may further be configured to estimate the FOV of the security personnel through: estimation of a location of the security personnel through one or more of radar, lidar, or ultrasound ranging, detection of a gaze direction of the security personnel, receipt of location information for the security personnel, detection of one or more of a gaze direction and a head tilt of the security personnel based on information received from a compass based sensor or a gyroscopic sensor on the security personnel, estimation of the FOV based on the location and the one or more of the gaze direction and the head tilt, capture of images of the security personnel's face from feed from at least two image capture devices; and estimation of a gaze direction and head tilt of the security personnel based on an analysis of the captured images.

The processor may also be configured to estimate the FOV of the identified image capture device through: receipt of characteristic information associated with the identified image capture device, wherein the characteristic information comprises one or more of an azimuth, an elevation, an angle of view, and a focal; and computation the FOV of the identified image capture device based on the characteristic information. The processor may further be configured to provide the content from the image capture device to a display device at a security control center with an indication of the low priority, temporarily block the content provided by the image capture device from being displayed at a security control center until the overlap amount drops below the threshold and the content is no longer assigned the low priority, update the estimated FOV of the security personnel periodically or in response to a detection of one of a location change, a gaze direction change, or a head tilt change by the security personnel; and update the determined overlap amount between the FOV of the image capture device and the FOV of the security personnel based on the updated estimated FOV.

According to other examples, a surveillance system configured to provide prevention of duplicate monitored areas in a surveillance environment is described. The surveillance system may include a plurality of surveillance image capture devices communicatively coupled to a workstation, a data store communicatively coupled to the workstation and configured to store surveillance related data, the workstation for management of the surveillance system, wherein the workstation comprises a display device configured to display feeds from the plurality of surveillance image capture devices and the surveillance related data from the data store; and a server configured to control the plurality of surveillance image capture devices, the data store, and the workstation. The server may include a communication interface configured to facilitate communication the plurality of surveillance image capture devices, the data store, and the workstation, a memory configured to store instructions; and a processor coupled to the memory and the communication interface. The processor may be configured to estimate a field of view (FOV) of a security personnel, identify an image capture device with a coverage area that potentially includes the FOV of the security personnel, estimate a FOV of the identified image capture device, determine an overlap amount between the estimated FOV of the image capture device and the estimated FOV of the security personnel; and when the overlap amount exceeds a threshold, assign a low priority to content provided by the image capture device.

According to some examples, the processor may be further configured to estimate the FOV of the security personnel through: receipt of location information for the security personnel, detection of one or more of a gaze direction and a head tilt of the security personnel; and generation of a model for the FOV as a two-dimensional pie section based on the detected one or more of the gaze direction and the head tilt of the security personnel, the two-dimensional pie section having an origin, a radius, and a span, wherein the model has the security personnel being located at the origin of the pie section, the radius corresponds to an estimated depth of field, and the span corresponds to estimated visible range of the security personnel. The processor may be also configured to generate the model for the FOV through adjustment of the radius as inversely proportional to a density of people identified in a vicinity of the security personnel. The processor may be further configured to estimate the FOV of the security personnel through: receipt of location information for the security personnel, detection of one or more of a gaze direction and a head tilt of the security personnel; and determination of an azimuth and an elevation of the FOV of the security personnel from the detected gaze direction and the detected head tilt. The processor may be also configured to estimate the FOV of the security personnel through: receipt of location information for the security personnel, detection of one or more of a gaze direction and a head tilt of the security personnel; and generation of a model for the FOV as a three-dimensional pie section based on the detected one or more of the gaze direction and the head tilt of the security personnel, the three-dimensional pie section having an origin, a radius, and a span, wherein the model for the FOV has the security personnel being located at the origin of the pie section, the radius corresponds to an estimated depth of field, the span corresponds to estimated visible range of the security personnel, and the three-dimensional pie section is horizontally centered around the gaze direction and vertically centered around the head tilt.

According to further examples, the processor may further be configured to generate the model for the FOV further comprises adjusting the radius as inversely proportional to a density of people identified in a vicinity of the security personnel. The processor may also be configured to estimate the FOV of the security personnel through: receipt of global positioning system (GPS) information from a wearable device or a mobile device on the security personnel, detection of a gaze direction of the security personnel, detection of the security personnel on feeds from two or more image capture devices, computation of a location of the security personnel based on an analysis of the feeds from the two or more image capture devices, detection of one or more of a gaze direction and a head tilt of the security personnel from the feeds from the two or more image capture devices; and computation of the FOV of the security personnel based on an analysis of the detected one or more of the gaze direction and the head tilt. The processor may further be configured to estimate the FOV of the security personnel through: estimation of a location of the security personnel through near-field communication with a wearable device or a mobile device on the security personnel, detection of a gaze direction of the security personnel, estimation of a location of the security personnel through wireless local area network triangulation or cellular communication triangulation of a wearable device or a mobile device on the security personnel, detection of a gaze direction of the security personnel, estimation of a location of the security personnel through ranging from known locations of two or more image capture devices, and detection of a gaze direction of the security personnel. The processor may also be configured to estimate the FOV of the security personnel through: estimation of a location of the security personnel through one or more of radar, lidar, or ultrasound ranging, detection of a gaze direction of the security personnel, receipt of location information for the security personnel, detection of one or more of a gaze direction and a head tilt of the security personnel based on information received from a compass based sensor or a gyroscopic sensor on the security personnel, estimation of the FOV based on the location and the one or more of the gaze direction and the head tilt, capture of images of the security personnel's face from feed from at least two image capture devices; and estimation of a gaze direction and head tilt of the security personnel based on an analysis of the captured images.

According to yet other examples, the processor may further be configured to estimate the FOV of the identified image capture device through: receipt of characteristic information associated with the identified image capture device, wherein the characteristic information comprises one or more of an azimuth, an elevation, an angle of view, and a focal; and computation the FOV of the identified image capture device based on the characteristic information. The processor may also be configured to provide the content from the image capture device to a display device at a security control center with an indication of the low priority, temporarily block the content provided by the image capture device from being displayed at a security control center until the overlap amount drops below the threshold and the content is no longer assigned the low priority, update the estimated FOV of the security personnel periodically or in response to a detection of one of a location change, a gaze direction change, or a head tilt change by the security personnel; and update the determined overlap amount between the FOV of the image capture device and the FOV of the security personnel based on the updated estimated FOV.

According to some examples, a method to provide prevention of duplicate monitored areas in a surveillance environment is described. The method may include estimating a field of view (FOV) of a security personnel, identifying an image capture device with a coverage area that potentially includes the FOV of the security personnel, estimating a FOV of the identified capture device, determining an overlap amount between the estimated FOV of the image capture device and the estimated FOV of the security personnel; and determining whether the overlap amount exceeds a particular threshold.

According to other examples, the method may also include in response to a determination that the overlap amount exceeds the particular threshold, assigning a low priority to content provided by the image capture device and in response to a determination that the overlap amount exceeds the particular threshold, modifying the FOV of the image capture device. Modifying the FOV of the image capture device may include modifying one or more of a direction, a tilt, or a focus of the image capture device. The method may further include in response to a determination that the overlap amount exceeds the particular threshold, providing an instruction to the security personnel to modify the FOV of the security personnel. Providing the instruction to the security personnel to modify the FOV of the security personnel may include instructing the security personnel to modify one or more of a gaze direction, a head tilt, or a location of the security personnel.

There are various vehicles by which processes and/or systems and/or other technologies described herein may be effected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and designing the circuitry and/or writing the code for the software and/or firmware would be possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only, and is not intended to be limiting.

In addition, the mechanisms of the subject matter described herein are capable of being distributed as a program product in a variety of forms, and an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A method to provide prevention of duplicate monitored areas in a surveillance environment, the method comprising:
estimating a field of view (FOV) of a security personnel based on a gaze direction and a head tilt of the security personnel;
identifying an image capture device with a coverage area that potentially includes the FOV of the security personnel;
estimating a FOV of the identified image capture device based on one or more of an azimuth, an elevation, an angle of view, and a focus of the identified image capture device;
determining an overlap amount between the estimated FOV of the image capture device and the estimated FOV of the security personnel;
determining whether the overlap amount exceeds a threshold; and
in response to a determination that the overlap amount exceeds the threshold, assigning a low priority to content provided by the image capture device.

2. The method of claim 1, wherein estimating the FOV of the security personnel comprises:
receiving location information for the security personnel;
detecting one or more of the gaze direction and the head tilt of the security personnel; and
modelling the FOV as a two-dimensional or three-dimensional pie section based on the detected one or more of the gaze direction and the head tilt of the security personnel, the pie section having an origin, a radius, and a span, wherein the modelled FOV has the security personnel being located at the origin of the pie section, the radius corresponds to an estimated depth of field, the span corresponds to estimated visible range of the security personnel, and the pie section is horizontally centered around the gaze direction and vertically centered around the head tilt.

3. The method of claim 2, wherein modelling the FOV further comprises adjusting the radius as inversely proportional to a density of people identified in a vicinity of the security personnel.

4. The method of claim 1, wherein estimating the FOV of the security personnel further comprises:
detecting one or more of the gaze direction and the head tilt of the security personnel; and
determining an azimuth and an elevation of the FOV of the security personnel from the detected gaze direction and the detected head tilt.

5. (canceled)

6. (canceled)

7. The method of claim 1, wherein estimating the FOV of the security personnel further comprises one or more of:
receiving global positioning system (GPS) information from a wearable device or a mobile device on the security personnel; and
detecting the security personnel on feeds from two or more image capture devices and computing a location of the security personnel based on an analysis of the feeds from the two or more image capture devices; or
estimating the location of the security personnel through one or more of:
near-field communication with the wearable device or the mobile device on the security personnel,
wireless local area network triangulation or cellular communication triangulation of the wearable device or the mobile device on the security personnel,
ranging from known locations of two or more image capture devices, or
one or more of radar, lidar, or ultrasound ranging.

8-14. (canceled)

15. The method of claim 1, wherein estimating the FOV of the security personnel further comprises:
capturing images of the security personnel's face from feed from at least two image capture devices; and
estimating the gaze direction and head tilt of the security personnel based on an analysis of the captured images.

16. (canceled)

17. The method of claim 1, further comprising:
displaying the content provided by the image capture device at a security control center with an indication of the low priority; or
temporarily blocking the content provided by the image capture device from being displayed at the security control center until the overlap amount drops below the threshold and the content is no longer assigned the low priority.

18. (canceled)

19. (canceled)

20. The method of claim 1, wherein the FOV of the security personnel is one of the FOV of the security personnel's eyes and the FOV of
an image capture device associated with the security personnel.

21. The method of claim 20, wherein determining the overlap amount between the estimated FOV of the image capture device and the estimated FOV of the security personnel comprises:
comparing one or more markers detected in content from the image capture device associated with the security personnel and in content from the image capture device, wherein the one or more markers include one or more of a feature on a detected person, an architectural feature of the surveillance environment, or a lighting fixture.

22-33. (canceled)

34. A server configured to provide prevention of duplicate monitored areas in a surveillance environment, the server comprising:
a communication interface configured to facilitate communication between the server and a plurality of image capture devices in the surveillance environment;
a memory configured to store instructions associated with a surveillance application; and
a processor coupled to the communication interface and the memory, wherein the processor is configured to execute the surveillance application and perform actions comprising:
estimate a field of view (FOV) of a security personnel based on a gaze direction and a head tilt of the security personnel;
identify an image capture device with a coverage area that potentially includes the FOV of the security personnel;
estimate a FOV of the identified image capture device based on one or more of an azimuth, an elevation, an angle of view, and a focus of the identified image capture device;
determine an overlap amount between the estimated FOV of the image capture device and the estimated FOV of the security personnel; and
determine whether the overlap amount exceeds a threshold; and in response to a determination that the overlap amount exceeds the threshold, assign a low priority to content provided by the image capture device.

35. The server of claim 34, wherein the processor is configured to estimate the FOV of the security personnel through:
receipt of location information for the security personnel;
detection of one or more of gaze direction and head tilt of the security personnel; and
generation of a model for the FOV as a two-dimensional or three-dimensional pie section based on the detected one or more of the gaze direction and the head tilt of the security personnel, the pie section having an origin, a radius, and a span, wherein the model has the security personnel being located at the origin of the pie section, the radius corresponds to an estimated depth of field, the span corresponds to estimated visible range of the security personnel, and the pie section is horizontally centered around the gaze direction and vertically centered around the head tilt.

36. The server of claim 35, wherein the processor is configured to generate the model for the FOV through adjustment of the radius as inversely proportional to a density of people identified in a vicinity of the security personnel.

37-39. (canceled)

40. The server of claim 34, wherein the processor is configured to estimate the FOV of the security personnel through:
receipt of global positioning system (GPS) information from a wearable device or a mobile device on the security personnel;
detection of the security personnel on feeds from two or more image capture devices and computation of a location of the security personnel based on an analysis of the feeds from the two or more image capture devices; or
estimation of the location of the security personnel through one or more of:
near-field communication with the wearable device or the mobile device on the security personnel,
wireless local area network triangulation or cellular communication triangulation of the wearable device or the mobile device on the security personnel,
ranging from known locations of two or more image capture devices, or
one or more of radar, lidar, or ultrasound ranging.

41-49. (canceled)

50. The server of claim 34, wherein the processor is further configured to:
provide the content from the image capture device to a display device at a security control center with an indication of the low priority; or
temporarily block the content provided by the image capture device from being displayed at the security control center until the overlap amount drops below the threshold and the content is no longer assigned the low priority.

51. (canceled)

52. The server of claim 34, wherein the processor is further configured to:
update the estimated FOV of the security personnel periodically or in response to a detection of one of a location change, a gaze direction change, or a head tilt change by the security personnel; and
update the determined overlap amount between the FOV of the image capture device and the FOV of the security personnel based on the updated estimated FOV.

53. A surveillance system configured to provide prevention of duplicate monitored areas in a surveillance environment, the system comprising:
a plurality of surveillance image capture devices communicatively coupled to a workstation;
a data store communicatively coupled to the workstation and configured to store surveillance related data;
the workstation for management of the surveillance system, wherein the workstation comprises a display device configured to display feeds from the plurality of surveillance image capture devices and the surveillance related data from the data store; and
a server configured to control the plurality of surveillance image capture devices, the data store, and the workstation, wherein the server comprises:
a communication interface configured to facilitate communication the plurality of surveillance image capture devices, the data store, and the workstation;
a memory configured to store instructions; and
a processor coupled to the memory and the communication interface, the processor configured to:
estimate a field of view (FOV) of a security personnel based on a gaze direction and a head tilt of the security personnel;
identify an image capture device with a coverage area that potentially includes the FOV of the security personnel;
estimate a FOV of the identified image capture device based on one or more of an azimuth, an elevation, an angle of view, and a focus of the identified image capture device;
determine an overlap amount between the estimated FOV of the image capture device and the estimated FOV of the security personnel; and
determine whether the overlap amount exceeds a threshold; and
in response to a determination that the overlap amount exceeds the threshold, assign a low priority to content provided by the image capture device.

54. The surveillance system of claim 53, wherein the processor is configured to estimate the FOV of the security personnel through:
receipt of location information for the security personnel;
detection of one or more of a gaze direction and a head tilt of the security personnel; and
generation of a model for the FOV as a two-dimensional or three-dimensional pie section based on the detected one or more of the gaze direction and the head tilt of the security personnel, the pie section having an origin, a radius, and a span, wherein the model has the security personnel being located at the origin of the pie section, the radius corresponds to an estimated depth of field, the span corresponds to estimated visible range of the security personnel, and the pie section is horizontally centered around the gaze direction and vertically centered around the head tilt.

55-58. (canceled)

59. The surveillance system of claim 53, wherein the processor is configured to estimate the FOV of the security personnel through:
receipt of global positioning system (GPS) information from a wearable device or a mobile device on the security personnel;
detection of the security personnel on feeds from two or more image capture devices and computation of a location of the security personnel based on an analysis of the feeds from the two or more image capture devices; or
estimation of the location of the security personnel through one or more of:
near-field communication with the wearable device or the mobile device on the security personnel,
wireless local area network triangulation or cellular communication triangulation of the wearable device or the mobile device on the security personnel,
ranging from known locations of two or more image capture devices, or
one or more of radar, lidar, or ultrasound ranging.

60-68. (canceled)

69. The surveillance system of claim 53, wherein the processor is further configured to:
provide the content from the image capture device to a display device at a security control center with an indication of the low priority; or
temporarily block the content provided by the image capture device from being displayed at the security control center until the overlap amount drops below the threshold and the content is no longer assigned the low priority.

70-73. (canceled)

74. The method of claim 1, further comprising:
in response to a determination that the overlap amount exceeds the particular threshold,
modifying the FOV of the image capture device, or
providing an instruction to the security personnel to modify the FOV of the security personnel.

75-77. (canceled)
